(19) United States
(12) Patent Application Publication
(10) Pub. No.: US 2019/0147890 A1
(43) Pub. Date: May 16, 2019

(54) AUDIO PERIPHERAL DEVICE

(71) Applicant: Cirrus Logic International Semiconductor Ltd., Edinburgh (GB)

(72) Inventors: Michael PAGE, Stonehouse Gloucestershire (GB); Thomas Ivan HARVEY, Northcote (AU)

(73) Assignee: Cirrus Logic International Semiconductor Ltd., Edinburgh (GB)

(21) Appl. No.: 16/186,955

(22) Filed: Nov. 12, 2018

Related U.S. Application Data
(60) Provisional application No. 62/585,085, filed on Nov. 13, 2017.

(30) Foreign Application Priority Data
Dec. 7, 2017 (GB) 1720418.1

(51) Int. Cl. G10L 17/22; G10L 17/00; G10L 17/06; H04R 1/40; H04R 3/00

(52) U.S. Cl. CPC G10L 17/22; G10L 17/005; H04R 3/005; H04R 1/406; G10L 17/06

(57) ABSTRACT

There is provided a method in a peripheral device comprising one or more microphones. The peripheral device is connectable to a host device via a digital connection. The method comprises: receiving, from the one or more microphones, an audio data stream relating to speech from a user, the audio data stream comprising a stream of data segments; and, responsive to detection of a trigger phrase in one or more first data segments of the audio data stream: effecting activation of the digital connection; and transmitting one or more biometric features extracted from the one or more first data segments to the host device via the digital connection for use in a voice biometric authentication process.

### TECHNICAL FIELD

Embodiments of the present disclosure relate to voice biometric authentication, and particularly to methods and apparatus for reducing the latency of voice biometric authentication when using a peripheral device to capture audio input.

### BACKGROUND

Voice user interfaces are provided to allow a user to interact with a system using their voice. One advantage of this, for example in devices such as smartphones, tablet computers and the like, is that it allows the user to operate the device in a hands-free manner.

In one typical system, the user wakes the voice user interface from a low-power standby mode by speaking a trigger phrase, potentially followed by one or more command phrases. Speech recognition techniques are used to detect that the trigger phrase has been spoken and to identify the actions that have been requested in the one or more command phrases. The trigger phrase may be predefined with the system (e.g. through a prior enrolment phrase), such that the processing necessary to detect the trigger phrase is significantly simpler and less computationally intensive than that required for general speech recognition. This enables the electronic device to be in a low-power state while continually monitoring input signals from one or more microphones for the presence of trigger phrase. Well-known examples of trigger phrases include “Hey Siri”® and “OK Google”®.

Speaker recognition techniques may then be applied to the speech to determine whether or not the user is an authorised user, and whether a restricted action should be carried out (e.g. whether the device should wake from its standby mode, or whether the requested actions should be carried out).

Users are increasingly using peripheral devices in conjunction with their host devices for the capture of audio through microphones. Examples of such peripheral devices include headsets and smart watches or other wearable devices such as smart glasses. Such peripheral devices are personal to their user or wearer; however, other peripheral devices are known which are not personal to any one particular user. For example, home assistant devices are becoming more popular, and may comprise one or multiple remote units for the capture of audio to be processed by a central hub device.

Such peripheral devices may be connected to a host device (e.g., a smartphone, tablet computer, home assistant hub, etc) via a wired or wireless digital connection. Examples of wired connections include USB connectors, while examples of wireless connections include Bluetooth® and its variants, and other short-range wireless protocols. In order to conserve power in the peripheral device and also the host device, the digital connection may be placed in a low-power state when not required. Suitable examples of a low-power state include sleep states, or deactivation of the connection entirely. The digital connection may be placed in such a low-power state following a period of inactivity, or following a suitable user command placing one or more of the peripheral device and the host device in a similar low-power state.

However, this may have some disadvantages, in that the digital connection is unavailable at the point of a user uttering a trigger phrase intended to wake the system.

Embodiments of the disclosure seek to address these and other issues.

### SUMMARY

In one aspect there is provided a method in a peripheral device comprising one or more microphones. The peripheral device is connectable to a host device via a digital connection. The method comprises: receiving, from the one or more microphones, an audio data stream relating to speech from a user, the audio data stream comprising a stream of data segments; and, responsive to detection of a trigger phrase in one or more first data segments of the audio data stream: effecting activation of the digital connection; and transmitting one or more biometric features extracted from the one or more first data segments to the host device via the digital connection for use in a voice biometric authentication process.

Another aspect of the disclosure provides an audio transmission device for a peripheral device. The peripheral device comprises one or more microphones, and is connectable to a host device via a digital connection. The audio transmission device comprises: a first input for receiving, from the one or more microphones, an audio data stream relating to speech from a user, the audio data stream comprising a stream of data segments; trigger-phrase detection circuitry, configured to detect a trigger phrase in one or more first data segments of the audio data stream; and interface circuitry, configured to: effect activation of the digital connection responsive to detection of the trigger phrase; and transmit one or more biometric features extracted from the one or more first data segments to the host device via the digital connection for use in a voice biometric authentication process.

Further aspects of the disclosure provide a peripheral device, comprising one of more microphones, and an audio transmission device as set out above; and a combination of such a peripheral device and a host device comprising a voice biometric authentication module. The voice biometric authentication module is configured to receive the one or more biometric features, and to perform a voice biometric authentication algorithm using the one or more biometric features to determine whether or not the user is an authorised user.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 is a timing diagram showing conventional transfer of audio data between a peripheral device and a host device;

FIG. 2 is a schematic diagram showing a peripheral device and a host device according to embodiments of the disclosure;

FIG. 3 is a timing diagram showing transfer of audio data between a peripheral device and a host device according to embodiments of the disclosure; and

FIG. 4 is a flowchart of a method according to embodiments of the disclosure.

### DETAILED DESCRIPTION

For clarity, it will be noted here that this description refers to speaker recognition and to speech recognition, which are intended to have different meanings. Speaker recognition refers to a technique that provides information about the identity of a person speaking.

For example, speaker recognition may determine the identity of a speaker, from amongst a group of previously registered individuals, or may provide information indicating whether a speaker is or is not a particular individual, for the purposes of identification or authentication. Speech recognition refers to a technique for determining the content and/or the meaning of what is spoken, rather than recognising the person speaking.

According to embodiments of the disclosure, the peripheral device itself comprises a device for the detection of a trigger phrase spoken by the user. Upon detection of the trigger phrase, interface circuitry within the peripheral device effects activation of the digital connection with a host device.

Thus, by providing a trigger-phrase detect module or device within the peripheral device, a user may utilize the peripheral device to wake an electronic device from a low-power sleep state. Further, the host device (the digital connection to it) may enter a low-power state when not in use, saving battery resources in the host device and the peripheral device.

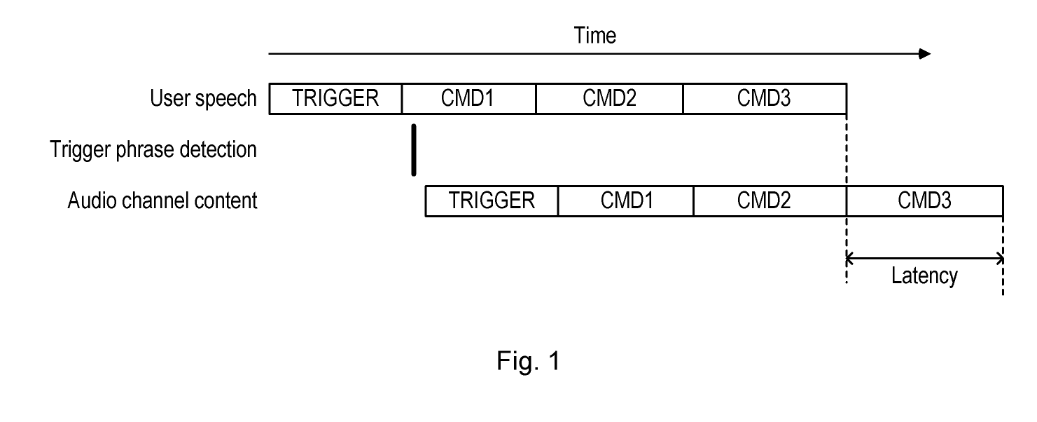

When peripheral devices are used to capture audio in the context of speech and speaker recognition processes, however, this low-power state can have some disadvantages. FIG. 1 is a timing diagram illustrating the problem.

For the purposes of FIG. 1, we assume that the peripheral device comprises circuitry or a module for the detection of a trigger phrase in speech from a user, but does not have any capacity to carry out a biometric speaker recognition process which is instead provided on the host device. It is further assumed that the digital connection between the peripheral device and its associated host device is initially in the low-power state.

A user may thus speak the trigger phrase, and optionally follow that with one or more commands containing instructions or requests for one or more actions to be carried out. The command phrases are represented by sequential command data segments (CMD1, CMD2 and CMD3), although it will be noted that each data segment may comprise only part of a single command or multiple commands.

Upon detection of the trigger phrase in the speech captured by the peripheral device, the trigger-phrase detection module generates a detection event and activates the digital connection with the host device. Once active, the audio data can be transmitted to the host device via the digital connection.

The problem with this approach is that latency is introduced equal to approximately the amount of time taken for the user to speak the trigger phrase. Data is not and cannot be transmitted to the host device until the trigger phrase is detected and the digital connection activated. A typical trigger phrase may be spoken in approximately one second, meaning that the host device will not receive the audio signal until one second after the user has spoken. Processes in the host device which utilize that audio data (such as speech and speaker recognition processes) are therefore delayed.

In order to address the issue of latency in transmission of audio data between a peripheral device and a host device, further embodiments of the present disclosure provide methods and apparatus whereby, upon detection of a trigger phrase, biometric features are extracted from the trigger phrase and the biometric features are transmitted from the peripheral device to the host device instead of the trigger phrase audio itself. In this way, the following command phrases may be analysed by a speech recognition process (and thus implemented) at an earlier time than would otherwise be the case.

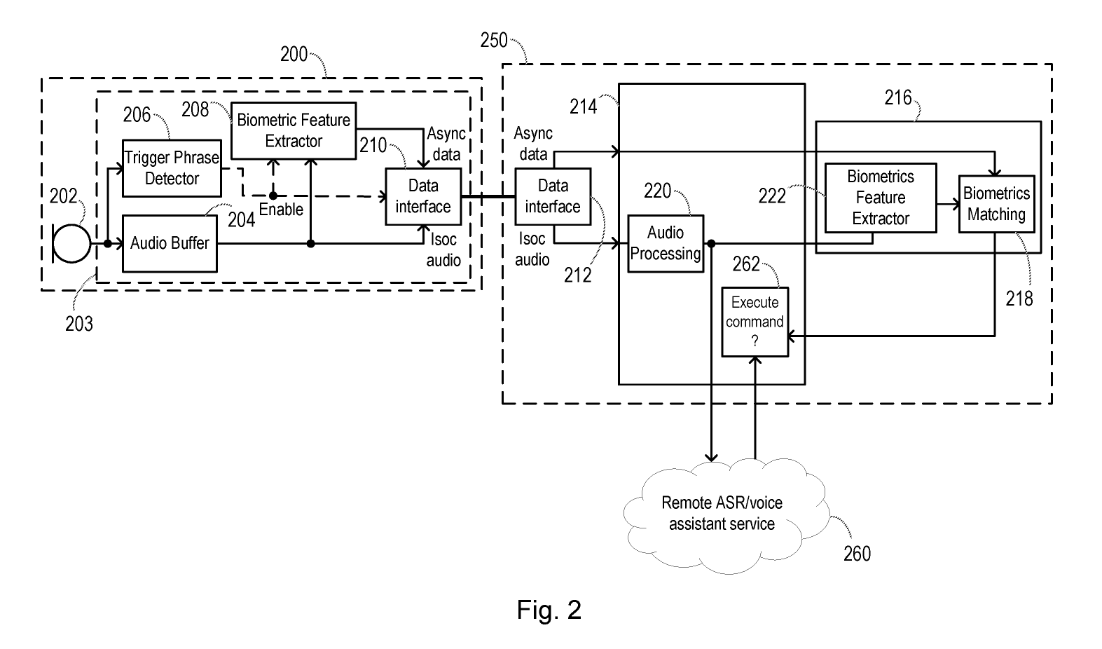

FIG. 2 shows a peripheral device 200 and a host device 250 in accordance with one aspect of the disclosure.

The peripheral device 200 may be any suitable type of device comprising one or more microphones for the capture of audio from a user. For example, the peripheral device 200 may be a headset, a smart device, a smart watch, smart glasses or a home automation remote device. In this context, the term “headset” is defined to mean any device comprising one or more speakers for the output of personal audio to a user, and one or more microphones for the capture of voice audio from that user. The headset may or may not comprise a band designed to worn over the top of a user's head, and for example may be a set of earphones with an associated voice microphone.

The host device 250 may be any suitable type of device, such as a mobile computing device for example a laptop or tablet computer, a games console, a remote control device, a home automation controller or a domestic appliance including a domestic temperature or lighting control system, a toy, a machine such as a robot, an audio player, a video player, or the like, but in this illustrative example the device is a mobile telephone, and specifically a smartphone 250. The smartphone 250 may, by suitable software, be used as the control interface for controlling a further device or system.

The peripheral device 200 comprises one or more microphones 102 operable to detect the voice of a user. The microphones 202 are coupled to an audio transmission device 203.

The audio transmission device 203 comprises a buffer memory 204, which is coupled to receive audio input signals from the one or more microphones 202. The buffer memory 204 may be circular, in that audio data is written to the memory 204 until it is full and, once full, new data is written over a previously used location (e.g. the starting location of the buffer).

Here it is noted that the audio data stream output by the microphone(s) 202 may be digital or analogue. In the latter case, the audio transmission device 203 may comprise an analogue-to-digital converter (ADC) which converts the audio data stream into the digital domain prior to its input to the buffer memory 204.

The audio transmission device 203 further comprises a trigger phrase detector 206 which, in the illustrated embodiment, is also coupled to receive the audio input signals from the one or more microphones 202. In alternative embodiments, the trigger phrase detector 206 is coupled to the buffer memory 204 and analyses the contents of that memory to determine the presence of a trigger phrase. In either case, the trigger-phrase detector 206 is configured to detect the presence of a predefined trigger phrase in the audio data captured by the one or more microphones. The trigger phrase detector 206 uses speech recognition techniques for determining whether the audio input contains a specific predetermined phrase, referred to herein as a trigger phrase or pass phrase. Well-known examples of such phrases include “Hey Siri”® and “OK Google”®. The trigger phrase detector 206 may comprise a speech processor, for example.

Upon detection of the trigger phrase, the trigger phrase detector 206 outputs an enable command signal to a biometric feature extractor 208 and also to interface circuitry 210 comprised within the audio transmission device 203. In the illustrated embodiment, the biometric feature extractor 208 is provided within the audio transmission device 203.

Upon receipt of the enable command signal, the biometric feature extract device 208 is configured to extract one or more biometric features from the audio signal for use in a biometric authentication process (e.g., a speaker recognition process). For example, the biometric feature extract device 208 may be coupled to the buffer memory 204 and configured to extract the one or more biometric features from the contents of the buffer memory 204. In particular, the biometric feature extract device 208 is configured to extract features from one or more data segments corresponding to the trigger phrase spoken by the user. At the point that the enable command message is generated, this may correspond to the only data segments stored in the buffer memory 204, or to one or more most-recent data segments stored in the buffer memory 204. Alternatively, the enable command signal may comprise an indication of the relevant data segments corresponding to the detected trigger phrase.

As used herein, biometric features are those features (i.e. parameters) which can be used as an input to a biometric authentication process for comparison to one or more corresponding features in a stored “voiceprint” for an authorised user.

The speaker recognition process may use a particular background model (i.e. a model of the public at large) and a model of the user's speech or “voiceprint” (i.e. as acquired during a previous enrolment process) as its inputs, and compare the relevant voice segment with these models, using a specified verification method to arrive at an output. Features of the user's speech are obtained from the relevant voice segment, and these features are compared with the features of the background model and the relevant user model. Thus, each speaker recognition process can be considered to comprise the background model, the user model, and the verification method or engine that are used. The output (also referred to herein as the biometric authentication result) may comprise a biometric score of the likelihood that a speaker is an authorised user (say, as opposed to a general member of the public). The output may further or alternatively comprise a decision as to whether the speaker is an authorised user. For example, such a decision may be reached by comparing the score to a threshold.

Those skilled in the art will appreciate that, depending on the type of verification method or engine implemented in the speaker recognition process, different biometric features may be extracted from the audio. For example, the extracted features may comprise one or more of: mel frequency cepstral coefficients, perceptual linear prediction coefficients, linear predictive coding coefficients, deep neural network-based parameters, and i-vectors.

Upon receipt of the enable command signal, the interface circuitry 210 is configured to activate a (previously low-power) digital connection to the host device 250. The digital connection may be wired or wireless. Examples of wired connections include USB connectors, while examples of wireless connections include Bluetooth® and its variants, and other short-range wireless protocols. Such activation may comprise activating the digital connection from a previous deactivated state, or from a previous sleep or standby state. The activation may comprise one or more of: a process of discovery; a process of synchronization with the host device 250; an exchange of digital signatures with the host device; a notification transmitted from the audio transmission device 200 to the host device 250 that a trigger phrase has occurred. The interface circuitry 210 may further effect activation of the digital connection by changing its status to a “reported” or similar state. For example, the host device 250 may periodically activate the digital connection to poll the status of the peripheral device 200. By changing the status to a reported state and waiting for the host device 250 to poll upon its next periodic activation of the digital connection, the interface circuitry 210 effects activation of the digital connection. The digital connection may be managed and activated by the interface circuitry 210 in communication with corresponding interface circuitry 212 in the host device 250.

In some embodiments of the disclosure, the digital connection may comprise multiple channels via which data can be transmitted. For example, the digital connection may comprise an audio channel for the isochronous transmission of audio data, and a side channel for the asynchronous transmission of general data. The audio channel may have a higher bandwidth than the side channel.

When the digital connection is wired, the audio and side channels may be provided on separate input/output connections of that digital connection. When the digital connection is wireless, the audio and side channels may be transmitted via separate logical channels of the wireless digital connection.

In an alternative embodiment, however, the side channel may form part of the audio channel. In this embodiment, the side channel may be encoded at ultrasonic frequencies (that is, frequencies which are higher than those audible to the human ear), and provided with the audio data stream itself. Alternatively, if the audio content has substantially lower bandwidth than human hearing (e.g. as is often the case with speech recognition systems that use 16 kHz sample rate for <8 kHz bandwidth), but the audio channel has a higher bandwidth (e.g. >20 kHz bandwidth) due to the need to have full-bandwidth playback path and the same sample rate for playback and capture paths, then there may be unused bandwidth at the higher frequencies of the audio channel (e.g. between 8 kHz and −20 kHz). This bandwidth may be used high frequency, but not ultrasonic. In either case, a high-frequency audio modem may be used to achieve such encoding.

The extracted features are output from the biometric feature extract device 208 to the interface circuitry 210 for transmission over the digital connection. Similarly, the interface circuitry 210 may be coupled to the buffer memory 204 and configured to receive the audio data stream for transmission over the digital connection. According to embodiments of the disclosure, the biometric features may be transmitted over the side channel, while the audio data stream may be transmitted over the audio channel.

In order to maintain security in the transmission of biometric data, the extracted features may be subject to a cryptographic process prior to their transmission over the digital connection. For example, the audio transmission device 203 may have an associated private-public cryptographic key pair, with the public key of that pair being provided to connected devices (such as the host device 250) during an initial handshake process upon activation of the digital connection. In cryptographically signing the data in this way, the private cryptographic key of that key pair may be applied to the biometric features (e.g. used to sign or encrypt the biometric features). Alternatively, a cryptographic key which is shared secretly with the receiving device (in this case the host device 250) may be applied to the extracted features. In either case, the biometric features may be cryptographically signed or encrypted by a cryptographic module (not illustrated) in the audio transmission device 203, prior to their output to the interface circuitry 210.

The audio data stream is also output over the now-active digital connection. However, according to embodiments of the disclosure, data segments corresponding to the detected trigger phrase are not output. At the point that the enable command message is received by the interface circuitry 210 from the trigger-phrase detector 206, this may correspond to the only data segments stored in the buffer memory 204, or to only the one or more most-recent data segments stored in the buffer memory 204. Thus the interface circuitry 206 may transmit only those data segments added to the buffer memory after the enable command signal is received from the trigger-phrase detector 206. Alternatively, the enable command signal may comprise an indication of the relevant data segments corresponding to the detected trigger phrase, with the interface circuitry omitting those data segments from its transmissions to the host device (or only transmitting those data segments added to the buffer memory 204 after the indicated data segments).

Those skilled in the art will appreciate that alternative embodiments may achieve substantially the same effect to those described above. For example, the biometric feature extractor 208 may continuously extract one or more biometric features from the audio data stream (not necessarily in response to detection of a trigger phrase), and store those features in a buffer memory (such as the buffer memory 204). The relevant extracted features (i.e. those relating to the first data segments or the trigger phrase) may then be transmitted upon detection of the trigger phrase.

The host device 250 comprises interface circuitry 212 which is coupled to the interface circuitry 210 via the now-active digital connection. The host device 250 further comprises an applications processor (AP) 214 and a secure voice biometrics processor or speaker recognition processor (SRP) 216. In the illustrated embodiment, the interface circuitry 212 is coupled directly to both the AP 214 and the SRP 216, while the AP 214 and the SRP 216 are also coupled to each other. However, those skilled in the art will appreciate that alternative configurations are possible and the present disclosure is not limited in that respect. For example, in alternative embodiments, the SRP 216 may be connected to the interface circuitry 212 only through the AP 214, or the AP 214 may be connected to the interface circuitry 212 only through the SRP 216. Further, in the illustrated embodiment the AP 214 and the SRP 216 are shown as separate devices (i.e. on separate integrated circuits). While this may be the case, in alternative embodiments the AP 214 and the SRP 216 may be implemented on the same integrated circuit. For example, the SRP 216 may be implemented in a trusted execution environment (TEE) of the AP 214.

Further, the AP 214 may be any suitable processor (such as a central processing unit (CPU)) or processing circuitry.

The SRP 216 comprises a biometric feature extractor module 222 and a biometric matching module 218. The biometric feature extractor module 222 may be substantially similar to the biometric feature extract device 208, or otherwise carry out substantially the same functions in extracting one or more biometric features from an audio data stream for use in a voice biometric authentication process. The biometric matching module 218 is configured to compare these features with the features of a background model and the relevant user model, as described above.

Upon receipt of the data from the peripheral device 200, the interface circuitry 212 decodes the data into the isochronous audio channel (i.e. the audio data stream) and the asynchronous side channel (i.e. the biometric features extracted from the trigger phrase). According to embodiments of the disclosure, the biometric features are output to the biometric matching module 218. The biometric features may be output directly to the biometric matching module 218 (i.e. without substantial further processing), to enable the generation of a biometric authentication result based on a comparison of those features to the stored user model and the background model.

In embodiments where the biometric features are subject to a cryptographic signature, a verification module (not illustrated) may process the signed or encrypted features, and particularly verify whether the features are signed or encrypted by a cryptographic signature which corresponds to a cryptographic signature associated with the audio transmission device 203. For example, the cryptographic verification module may apply the public key of the private—public key belonging to the audio transmission device 203. Alternatively, the cryptographic verification module may apply a cryptographic key previously shared secretly with the audio transmission device 203.

If the verification module verifies that the cryptographically signed or encrypted biometric features originate from the audio transmission device 203 (i.e. the features are signed or encrypted with a cryptographic signature which is associated with or matches the cryptographic signature belonging to the audio transmission device 203), the cryptographic module may output the biometric features to the biometric matching module 218. If the verification process fails, the biometric features may not be output to the biometric matching module 218, or any subsequent biometric authentication result may be invalidated.

Separately, the audio data stream (which comprises data segments corresponding to one or more command phrases uttered by the user) may be output to the AP 214, and specifically to an audio processing module 220 which may be implemented in the AP 214. The audio processing module may perform one or more audio processing algorithms on the audio data stream. For example the audio processing 220 may perform one or more of: gain changes, EQ equalization, sample rate conversion. In this way, it is noted that the audio data on which the speaker or speech recognition processes are performed may not be a bit-exact version of the audio signal detected by the microphones 202 and/or received at the interface circuitry 212 of the host device 250.

The output of the audio processing module 220 is passed to a speech recognition service 260. In the illustrated embodiment, the speech recognition service 260 is implemented in a server which is remote from the host device 260, and thus the audio data stream output from the audio processing module 220 may be transmitted via any suitable interface to the remote server. Speech recognition processes typically run on remote servers at the time of writing owing to the intensive processing required to recognize speech in an audio data stream. In future, the processing capabilities of electronic devices such as the host device 250 may have improved to the extent that speech recognition can be implemented within the host device 250. Thus the present disclosure is not limited in that respect.

The speech recognition service 260 processes the received audio data to determine the content and/or meaning of the command phrases contained within the data, and returns a digital representation of that content and/or meaning to the host device 250. For example, the command phrase may contain an instruction or request for the host device 250 to carry out a particular action.

The output of the speech recognition service 260 and the biometric authentication result output from the biometric matching module 218 are provided to a decision module 262 which, in the illustrated embodiment, is implemented in the AP 214. The decision module 262 decides, based on the biometric authentication result, whether or not to carry out the requested action.

As noted above, the biometric authentication result may comprise a biometric authentication score, indicating the likelihood that the speaker is an authorised user, or an indication as to whether the user has been identified as an authorised user (e.g. by comparison of the biometric authentication score to one or more thresholds). In the latter case, the decision module 262 may allow or prevent the request action from being performed in accordance with the indication as to whether the speaker is an authorised user or not: if the biometric authentication result indicates that the speaker is an authorised user, the action may be performed; if the biometric authentication result indicates that the speaker is not an authorised user, the action may not be performed.

If the biometric authentication result comprises a biometric authentication score (and not an explicit indication as to whether the speaker is an authorised user or not), the decision module 262 may compare the biometric authentication score to a threshold itself to determine whether or not the speaker is an authorised user. The value of the threshold may vary as a function of the requested action recognized in the speech and output from the speech recognition service 260. For example, certain actions may be associated with higher security requirements than others. A financial transaction may have a high security requirement (and consequently a high threshold), or a security requirement that varies with the value of the transaction, while the execution of an application or game may have a lower security requirement (and consequently a lower threshold).

Thus biometric features for at least the trigger phrase are extracted by circuitry in the peripheral device 200 before transmission to the host device 250.

In further embodiments of the disclosure, command data segments may be used to supplement the speaker recognition process carried out on the trigger phrase. Further detail on this aspect can be found in PCT patent application no PCT/GB2016/051954. Thus the audio processing module 220 outputs the audio data stream (which corresponds to the command phrases) to the biometric feature extract module 222. The biometric feature extract module 222 extracts biometric features (e.g. corresponding feature types to those extracted by the biometric feature extract device 208) and outputs those extracted features to the biometrics matching module 218. The biometric matching module 218 is then able to fuse the features from the trigger and command data segments, or to fuse intermediate results based on the features from the trigger and command data segments, and generate a biometric authentication result which is based on both the trigger phrase and the one or more subsequent command phrases.

Embodiments of the present disclosure provide a peripheral device comprising one or more microphones 202 and an audio transmission device 203. In the illustrated embodiment, the audio transmission device 203 comprises a buffer memory 204, a trigger-phrase detect module 206, a biometric feature extractor 208 and interface circuitry 210. The audio transmission device 203 may be implemented as a single integrated circuit, for example. In alternative embodiments, however, one or more of these features may be external to the audio transmission device and/or on a different integrated circuit. For example, the biometric feature extractor 208 may be provided in a separate device or integrated circuit. In such an embodiment, the audio transmission device 203 may comprise one or more inputs for receiving the extracted biometric features from the biometric feature extractor 208.

By providing a trigger-phrase detect module 206 in the peripheral device, embodiments of the disclosure permit the host device and its digital connection with the peripheral device to remain in a low-power state when not in use, thus saving battery resources in the host device.

It will further be understood by those skilled in the art that the extraction and transmission of biometric features in the peripheral device 200, rather than the host device 250, allows the speaker recognition and speech recognition processes to be initiated by the host device with must lower latency than would otherwise be the case.

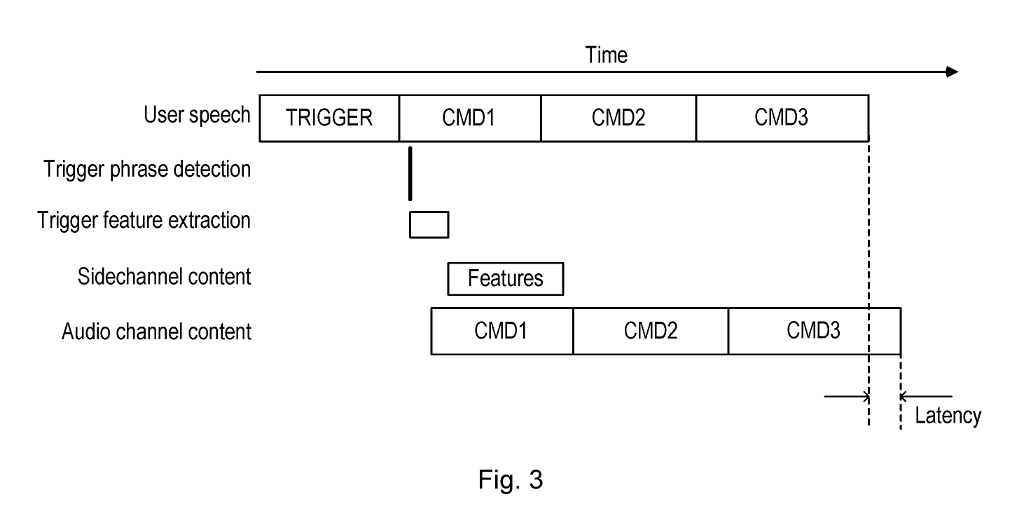

FIG. 3 is a timing diagram showing the transmission of audio data according to embodiments of the disclosure. The timing diagram follows the example shown in FIG. 1, described above, thus a digital connection between the peripheral device 200 and the host device 250 is initially in a low-power state, when a user speaks a trigger phrase following by one or more command phrases.

According to embodiments of the disclosure, upon detection of the trigger phrase (e.g. by trigger phrase detector 206), one or more biometric features are extracted from data segments corresponding to the detected trigger phrase. In addition, the digital connection between the peripheral device and the host device is activated.

The audio data stream acquired by the peripheral device is transmitted to the host device, e.g., as soon as practicable following activation of the digital connection. The audio data stream may utilize an isochronous audio data channel. However, data segments corresponding to the detected trigger phrase are not transmitted. Instead, the peripheral device transmits only the data segments corresponding to the one or more command phrases spoken by the user.

The extracted biometric features are also transmitted to the host device 250 via the activated digital connection. The biometric features may be transmitted via a side-channel in parallel with the audio data stream. The parallel transmission of the side-channel and the audio data stream may be literal (e.g. with the side-channel and the audio data stream transmitted at the same time), or logical (e.g. via time-domain multiplexing). For example, the biometric features may be transmitted via a separate low-bandwidth data channel, or encoded into the audio data stream itself (e.g. via an ultrasonic audio modem).

By this method, it can be seen that the audio data stream is transmitted to the host device with much lower latency than the conventional scheme illustrated with respect to FIG. 1. A speaker recognition process based on the extracted features can be carried out earlier, in parallel with other processing (such as speech recognition). Similarly, a speech recognition process can be carried out earlier than would otherwise be the case.

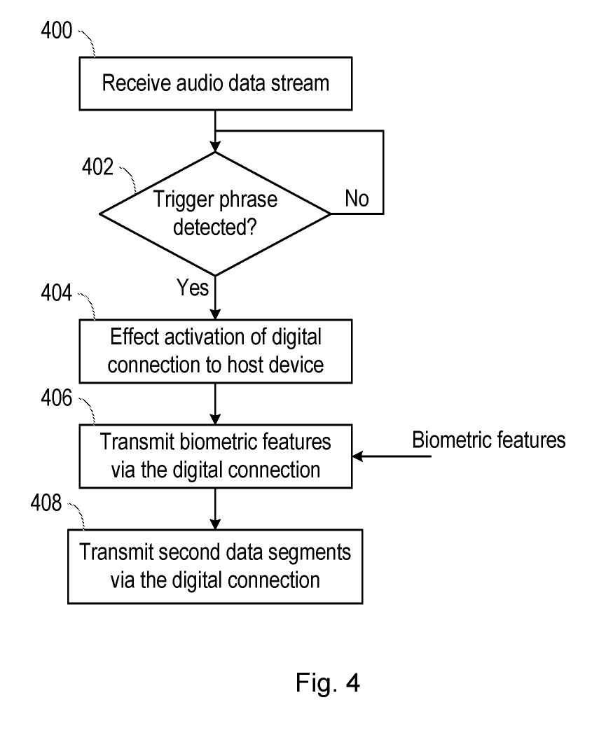

FIG. 4 is a flowchart of a method according to embodiments of the disclosure. The method may be carried out, for example, in an audio transmission device implemented within a peripheral device (such as the audio transmission device 203 described above). The peripheral device may be connectable to a host device via a digital connection (e.g. the host device 250 described above), and the digital connection is initially in a low-power or deactivated state.

In step 400, the audio transmission device receives an audio data stream from one or more microphones provided within the peripheral device, relating to speech from a user. For example, the speech may require authentication to authenticate the user as an authorised user. Alternatively, the user may simply be speaking to request that the host device carry out one or more actions (without requiring authentication). The audio data stream comprises one or more data segments (where each data segment comprises one or more data samples).

In step 402, the audio transmission device determines whether the audio data stream contains a pre-defined trigger phrase (e.g. a word, collection of words, or other sound which is pre-registered with the audio transmission device to act as a trigger for the audio transmission device or the host device). For example, the audio transmission device may comprise a trigger phrase detector to perform this step. If no such trigger phrase is detected, step 402 repeats until the trigger phrase is detected. The trigger phrase detector may consume relatively little power in this state, such that the peripheral device, the host device and/or the digital connection between them may remain in a low-power state.

Upon detection of the trigger phrase in one or more first data segments of the audio data stream, the method moves to step 404, in which the audio transmission device effects activation of the digital connection to the host device. The activation may comprise one or more of: a process of discovery; a process of synchronization with the host device; and an exchange of digital signatures with the host device. The audio transmission device may further effect activation of the digital connection by changing its status to a “reported” or similar state. For example, the host device may periodically activate the digital connection to poll the status of the peripheral device. By changing the status to a reported state and waiting for the host device to poll upon its next periodic activation of the digital connection, the audio transmission device effects activation of the digital connection.

In step 406, the audio transmission device transmits, to the host device via the digital connection, one or more biometric features extracted from the first data segments for use in a voice biometric authentication process. Those skilled in the art will appreciate that, depending on the type of verification method or engine implemented in the voice biometric authentication process (speaker recognition process), different biometric features may be extracted from the audio. For example, the extracted features may comprise one or more of: mel frequency cepstral coefficients, perceptual linear prediction coefficients, linear predictive coding coefficients, deep neural network-based parameters, and i-vectors.

The audio transmission device may comprise a biometric feature extract module for the extraction of the features, or an input for receiving the biometric features from an external biometric feature extract module. Further, the biometric features may be extracted upon detection of the trigger phrase (i.e. in response to detection of the trigger phrase) or, in other embodiments, biometric features may be continuously extracted from the audio data stream, and the relevant features (i.e. those corresponding to first data segments or trigger phrase) transmitted upon detection of the trigger phrase. The features may be cryptographically signed or encrypted prior to transmission.

In step 408, the audio transmission device transmits, to the host device via the digital connection, one or more second data segments of the audio data stream. These second data segments may relate to one or more command phrases which follow the trigger phrase, for example. The features transmitted in step 406 and the audio data transmitted in step 408 may be transmitted over first and second data channels of the digital connection. The first data channel may have a lower bandwidth than the second data channel. The first data channel may comprise an asynchronous data channel, and could be an encoded audio channel. The second data channel may comprise an isochronous audio channel.

The present disclosure thus provides methods, apparatus and computer-readable media which permit one or more of a peripheral device, a host device, and a digital connection between the two, to remain in a low-power state pending detection of a trigger phrase, thus saving battery resources, and to reduce the latency when a user seeks to control an electronic device through voice input to the peripheral device.

The skilled person will thus recognise that some aspects of the above-described apparatus and methods, for example the calculations performed by the processor may be embodied as processor control code, for example on a non-volatile carrier medium such as a disk, CD- or DVD-ROM, programmed memory such as read only memory (Firmware), or on a data carrier such as an optical or electrical signal carrier. For many applications embodiments of the disclosure will be implemented on a DSP (Digital Signal Processor), ASIC (Application Specific Integrated Circuit) or FPGA (Field Programmable Gate Array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

Embodiments of the disclosure may be arranged as part of an audio processing circuit, for instance an audio circuit which may be provided in a host device. A circuit according to an embodiment of the present disclosure may be implemented as an integrated circuit.

Embodiments may be implemented in a host device, especially a portable and/or battery powered host device such as a mobile telephone, an audio player, a video player, a PDA, a mobile computing platform such as a laptop computer or tablet and/or a games device for example. Embodiments of the disclosure may also be implemented wholly or partially in accessories attachable to a host device, for example in active speakers or headsets or the like. Embodiments may be implemented in other forms of device such as a remote controller device, a toy, a machine such as a robot, a home automation controller or suchlike.

It should be noted that the above-mentioned embodiments illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference signs in the claims shall not be construed so as to limit their scope.

1. A method in a peripheral device comprising one or more microphones, the peripheral device being connectable to a host device via a digital connection, the method comprising:
receiving, from the one or more microphones, an audio data stream relating to speech from a user, the audio data stream comprising a stream of data segments; and
responsive to detection of a trigger phrase in one or more first data segments of the audio data stream:
effecting activation of the digital connection; and
transmitting, to the host device via the digital connection, one or more biometric features extracted from the one or more first data segments for use in a voice biometric authentication process.

2. The method according to claim 15, further comprising transmitting one or more second data segments of the audio data stream, not including the one or more first data segments, to the host device via the digital connection.

3. The method according to claim 2, wherein the digital connection comprises a first data channel and a second data channel, wherein the one or more biometric features are transmitted over the first data channel and the one or more second data segments are transmitted over the second data channel.

4. The method according to claim 3, wherein the one or more second data segments comprise one or more command phrases uttered by the user.

5. An audio transmission device for a peripheral device, the peripheral device comprising one or more microphones, the peripheral device being connectable to a host device via a digital connection, the audio transmission device comprising:
a first input for receiving, from the one or more microphones, an audio data stream relating to speech from a user, the audio data stream comprising a stream of data segments;
trigger-phrase detection circuitry, configured to detect a trigger phrase in one or more first data segments of the audio data stream;
interface circuitry, configured to:
effect activation of the digital connection responsive to detection of the trigger phrase; and
transmit one or more biometric features extracted from the one or more first data segments to the host device via the digital connection for use in a voice biometric authentication process.

6. The audio transmission device according to claim 5, wherein the interface circuitry is further configured to transmit one or more second data segments of the audio data stream, not including the one or more first data segments, to the host device via the digital connection.

7. The audio transmission device according to claim 6, wherein the digital connection comprises a first data channel and a second data channel, wherein the one or more biometric features are transmitted over the first data channel and the one or more second data segments are transmitted over the second data channel.

8. The audio transmission device according to claim 7, wherein the first data channel has a lower bandwidth than the second data channel.

9. The audio transmission device according to claim 30, wherein the first data channel comprises an asynchronous data channel.

10. The audio transmission device according to claim 7, wherein the second data channel comprises an isochronous audio channel.

11. The audio transmission device according to claim 5, wherein the one or more second data segments comprise one or more command phrases uttered by the user.

12. The audio transmission device according to claim 5, further comprising:
a cryptographic device configured to sign or encrypt the one or more biometric features,
and wherein the interface circuitry is configured to transmit the one or more biometric features by transmitting the one or more cryptographically signed or encrypted biometric features.

13. The audio transmission device according to claim 5, further comprising:
a buffer memory for storing one or more audio input signals from the microphones.

14. The audio transmission device according to claim 15, wherein the one or more biometric features are extracted based on the content of the buffer memory.

15. The audio transmission device according to claim 12, wherein the trigger-phrase detection circuitry is configured to detect the trigger phrase based on the content of the buffer memory.

16. The audio transmission device according to claim 5, wherein the trigger-phrase detection circuitry is configured to detect the trigger phrase based on the audio input signals received from the one or more microphones.

17. The audio transmission device according to claim 5, further comprising a second input for receiving the one or more biometric features extracted from the one or more first data segments.

18. The audio transmission device according to claim 30, further comprising:
a feature extract device configured to extract the one or more biometric features from the one or more first data segments.

19. A peripheral device, comprising:
one of more microphones; and
an audio transmission device according to claim 5.

20. A combination, comprising:
a peripheral device according to claim 19; and
a host device comprising a voice biometric authentication module, wherein the voice biometric authentication module is configured to receive the one or more biometric features, and to perform a voice biometric authentication algorithm using the one or more biometric features to determine whether or not the user is an authorised user.
